(19) United States
(12) Patent Application Publication
(10) Pub. No.: US 2006/0202451 A1
(43) Pub. Date: Sep. 14, 2006

(54) CURTAIN AIRBAG DEVICE

(75) Inventor: Ryosuke NAKANISHI, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/275,872

(22) Filed: Feb. 1, 2006

(30) Foreign Application Priority Data
Mar. 11, 2005 (JP) 2005-069463

(51) Int. Cl. B60R 21/213; B60R 21/23

(52) U.S. Cl. 280/730.2; 280/743.2

(57) ABSTRACT

A side curtain airbag device that includes a linear member that extends substantially in the vertical direction to apply tension to the lower edge of the curtain airbag.

### BACKGROUND

The present invention relates to a curtain airbag device including a curtain airbag that can be deployed along an inner side surface of a vehicle cabin,

When a vehicle equipped with a curtain airbag device is involved in, for example, a side impact or rollover, curtain airbags are deployed downward along the inner side surfaces (for example, doors and pillars) of the vehicle cabin so as to protect the head of each vehicle occupant and to keep each vehicle occupant inside the vehicle cabin.

FIG. 4 illustrates a mechanism disclosed in Japanese Unexamined Patent Application Publication No. 2003-81048 (incorporated by reference herein), in which tension is applied along a lower edge of a curtain airbag deployed along an inner side surface of a vehicle cabin so that the lower edge of the curtain airbag is stretched in the vehicle's lateral direction.

In FIG. 4, the attachment tabs 1a provided on the upper edge of a curtain airbag 1 are fastened to a roof side-rail (not shown). When the curtain airbag 1 is in an undeployed state, the curtain airbag 1 is folded in an elongated configuration and is disposed along the roof side-rail.

In order to apply tension along the lower edge of the curtain airbag 1 in a deployed state, a wire 3 is provided so as to extend in the vertical direction, A lower rear portion of the curtain airbag 1 is provided with a pin 2 such that the wire 3 is supported by the pin 2. The upper and lower ends of the wire 3 are fastened to a C pillar via pins 4, 5, respectively. When the curtain airbag 1 is deployed downward so as to reach the state shown in FIG. 4, the wire 3 is stretched between the pins 2, 4, 5 resulting in tension being applied along the lower edge of the curtain airbag 1.

Since the wire 3 is engaged to the curtain airbag 1 via the pin 2, the conventional structure in FIG. 4 requires an excessive number of components due to the pin 2.

Accordingly, the object of the present invention is to provide a curtain airbag device, which has a tension-applying mechanism with a small number of components and a simple structure.

### SUMMARY

According to an embodiment of the present invention, a curtain airbag device is provided. According to an embodiment of the invention, the airbag is capable of being deployed downward along an inner side surface of a vehicle cabin; an inflator for supplying gas into the curtain airbag so as to deploy the curtain airbag; and a tension-applying member for applying tension to a lower edge of the curtain airbag in a deployed state. The tension-applying member may be a linear member extending in a vertical direction. A lower front portion or a lower rear portion of the curtain airbag is provided with an opening through which the linear member extends.

According to an embodiment of the present invention, an upper end of the linear member is preferably fastened to a vehicle body via a fastening member. The fastening member may also be provided for fastening the curtain airbag to the vehicle body.

According to an embodiment of the curtain airbag device of the present invention, since the linear member may extend through an opening provided in the lower portion of the curtain airbag, a component equivalent to the pin 2 in FIG. 4 becomes unnecessary. Thus, production costs are reduced.

According to an embodiment of the present invention, the upper end of the linear member may be fastened to the vehicle body via the fastening member, which is provided for fastening the curtain airbag to the vehicle body. Since the number of fastening members is reduced, production costs are reduced even further.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1(a) shows a perspective view illustrating an undeployed state of a curtain airbag according to an embodiment of the invention.

FIG. 1(b) shows a perspective view illustrating a deployed state of the curtain airbag according to an embodiment of the invention.

FIG. 2(a) is an enlarged view of FIG. 1(a) illustrating the attachment of the linear member before the airbag deployment.

FIG. 2(b) is a side view of FIG. 2(a).

FIG. 3(a) is an enlarged view of FIG. 1(b) illustrating the attachment of the linear member after the airbag deployment.

FIG. 3(b) is a side view of FIG. 2(a).

FIG. 4 is a schematic diagram of a conventional example of providing tension along a lower edge of a curtain airbag.

### DETAILED DESCRIPTION

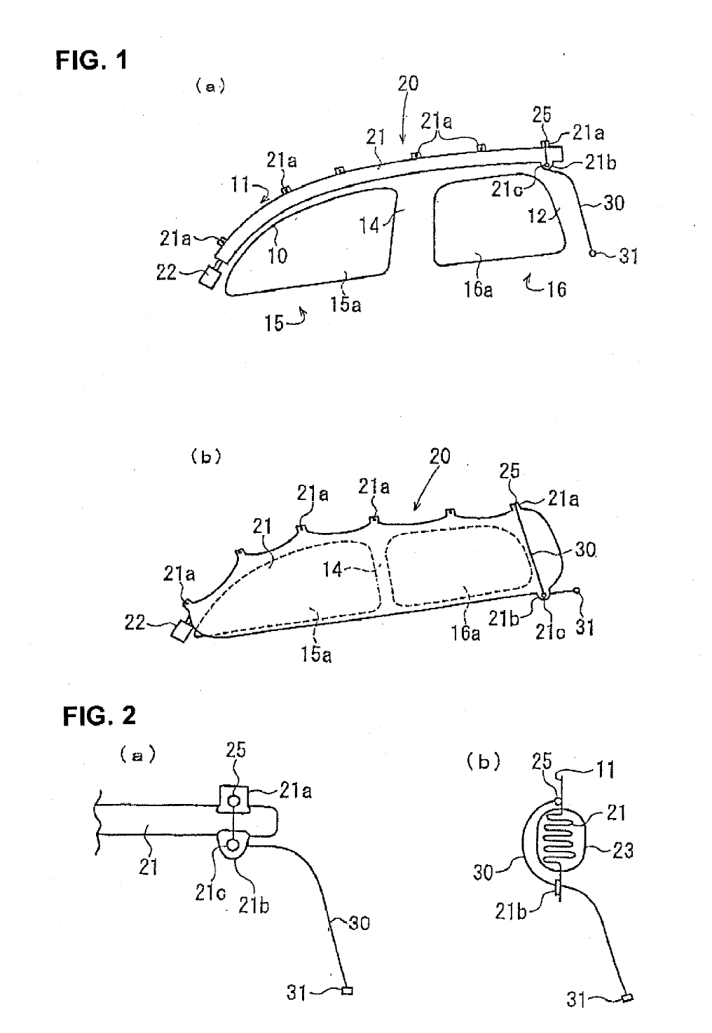

Embodiments of the present invention will now be described with reference to the drawings. In reference to FIGS. 1(a) and 1(b), a curtain airbag device 20 is disposed along a roof side-rail 11 and extends from an A pillar 10 of the vehicle to a C pillar 12. When the vehicle is involved in a side impact or a rollover, a curtain airbag 21 is deployed as a result of gas being sent from an inflator 22. As a result of the deployment, the curtain airbag 21 covers a B pillar 14 and the side windows 15a, 16a, which are provided in a front door 15 and a rear door 16, respectively.

The curtain airbag 21 is folded in an elongated configuration and is disposed along the roof side-rail 11 while being kept in its shape by a breakable tape 23, as depicted in FIG, 2(b). The curtain airbag 21 is covered with a roof-head lining (not shown).

A plurality of tabs 21a protrudes from an upper edge of the curtain airbag 21. The tabs 21a are fastened to the A pillar 10 and the roof side-rail 11 with fastening members 25, such as bolts and rivets.

A lower rear portion of the curtain airbag 21 is provided with a protrusion 21b extending downward. The protrusion 21b is provided with an opening 21c.

In order to apply tension to a lower edge of the curtain airbag 21 in the deployed state, a wire 30 defining a linear member is fed through the opening 21c and extends substantially in the vertical direction. In the embodiment shown in FIGS. 2(a) and 2(b), all upper end of the wire 30 is fastened to the roof side-rail 11 via one of the fastening members 25 disposed at the rearmost portion of the curtain airbag 21. The lower end of the wire 30 is fastened to the C pillar 12 via an anchor 31. The wire 30 has a length that is greater than the length of an imaginary straight line that connects the rearmost fastening member 25 and the anchor 31.

When a vehicle equipped with the curtain airbag device 20 is involved in a side impact or a rollover, the inflator 22 generates gas so as to start inflating the curtain airbag 21. Then, the curtain airbag 21 pushes open the lower edge of the roof-head lining. As a result, the curtain airbag 21 is deployed downward along the interior side of the windows 15a, 16a.

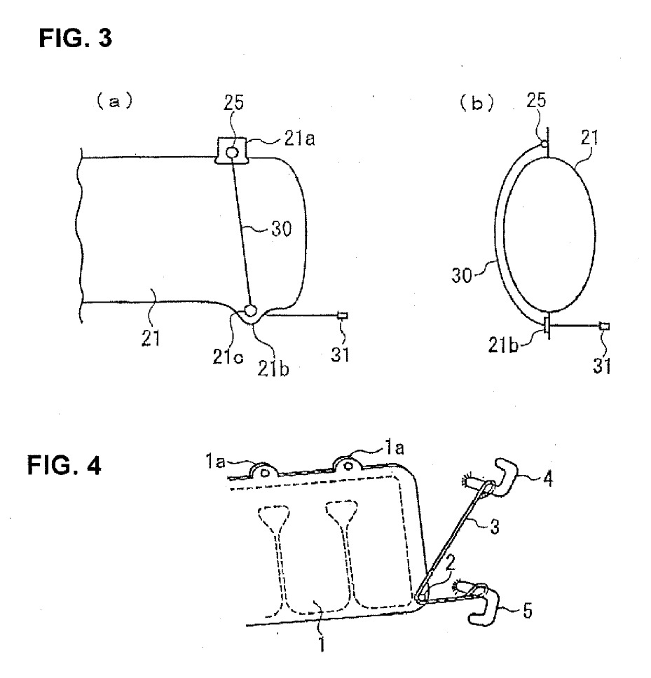

As shown in FIGS. 3(a) and 3(b), when the curtain airbag 21 is completely deployed, the wire 30 is stretched between the opening 21c and the fastening member 25 and between the opening 21c and the anchor 31, whereby tension is applied to the lower edge of the curtain airbag 21. In other words, since the anchor 31 is posterior to the protrusion 21b, the lower rear portion of the curtain airbag 21 is pulled towards the back of the vehicle via the wire 30, whereby tension is applied to the lower edge of the curtain airbag 21.

According to this embodiment, the wire 30 extending through the opening 21c provided in the curtain airbag 21 requires fewer components than the conventional arrangement, which results in a reduction in cost. Furthermore, since the upper end of the wire 30 is fastened to the roof side-rail 11 via one of the airbag fastening members 25, the component costs can be further reduced by standardizing the fastening members.

In this embodiment, when the curtain airbag 21 is being deployed to the state shown in FIG. 1(b) and FIG. 3(a), the wire 30 extends downward substantially in the vertical direction from the rearmost fastening member 25. Thus, the extending direction of the wire 30 and the deploying direction of the curtain airbag 21 are aligned with each other, whereby smooth downward deployment of the curtain airbag 21 is achieved.

Although the wire 30 is fastened to the C pillar 12 in the above-described embodiment, the wire 30 may alternatively be fastened to, for example, the B pillar or a D pillar depending on the size of the curtain airbag and the structure of the vehicle body. Furthermore, although the opening 21c is provided in the lower rear portion of the curtain airbag 21 in the above-described embodiment, the opening 21c may alternatively be provided in a lower front portion of the curtain airbag 21. I that case, the wire may be fastened to the A pillar.

Although a wire is used as the linear member in the above-described embodiment, the linear member may alternatively be defined by, for example, a rope, a belt, a tube, or a tape composed of a soft resin material.

The priority application, Japanese Patent Application No. 2005-69463, filed on Mar. 11, 2005 including the specification, drawings, claims and abstract, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An airbag system comprising:
a curtain airbag capable of being deployed downward along an inner surface of a vehicle cabin, wherein a lower portion of the curtain airbag is provided with an opening;
an inflator for supplying gas into the curtain airbag so as to deploy the curtain airbag; and
a tension-applying member for applying tension to a lower edge of the curtain airbag in a deployed state, wherein the tension-applying member is a linear member extending in a vertical direction, and
wherein the linear member extends through the opening in the curtain airbag.

2. The airbag system according to claim 1, further comprising a fastening member for fastening an end of the linear member to a vehicle body and for fastening the curtain airbag to the vehicle body.

3. The airbag system according to claim 1, wherein the linear member extends in a direction that is aligned with the deploying direction of the curtain airbag.

4. The airbag system according to claim 1, wherein the linear member comprises at least one of the following: a wire, a rope, a belt, a tube, or a tape composed of a soft resin material.

5. The airbag system according to claim 1, wherein the lower edge of the curtain airbag is the lower rear edge and wherein the tension-applying member is fastened to a C pillar of the vehicle.

6. A airbag system comprising.
a curtain airbag capable of being deployed downward along an inner surface of a vehicle cabin;
an inflator for supplying gas into the curtain airbag; and a tension-applying member for applying tension to a lower edge of the curtain airbag in a deployed state; and
a first fastening member for fastening a first end of the tension-applying member to a vehicle body and for fastening the curtain airbag to the vehicle body.

7. The airbag system according to claim 6, further comprises a second fastening member for fastening a second end of the tension-applying member to the vehicle body.

8. The airbag system according to claim 6, wherein a lower portion of the curtain airbag is provided with an opening and wherein the tension-applying member is a linear member extending through the opening of the curtain airbag.

9. An airbag system comprising:
a side curtain airbag configured to deploy along an inner side surface of a vehicle cabin;
a linear member for applying tension to a lower edge of the airbag when the airbag is deployed;
wherein the linear member is connected at one end to a top portion of the airbag and at the other end to a portion of the vehicle body located at or below the a bottom portion of the airbag when the airbag is deployed, and wherein the linear member passes through an opening in the bottom portion of the airbag.

10. The airbag system of claim 9, wherein the linear member is connected to a non-inflatable portion of the airbag.

11. The airbag system of claim 9, wherein the opening is located in a non-inflatable region of the airbag.

12. The airbag system of claim 9, wherein the opening is located at a rear portion of the airbag.

13. The airbag system of claim 9, wherein the linear member extends generally vertically between the opening and the top portion of the airbag.
